(19) United States
(12) Patent Application Publication
(10) Pub. No.: US 2016/0140857 A1
(43) Pub. Date: May 19, 2016

(54) PERSONALIZED AND TARGETED TRAINING

(71) Applicant: Andres Jimenez, Dallas, TX (US)

(72) Inventor: Andres Jimenez, Dallas, TX (US)

(21) Appl. No.: 14/940,169

(22) Filed: Nov. 13, 2015

Related U.S. Application Data
(60) Provisional application No. 62/080,347, filed on Nov. 16, 2014.

(51) Int. Cl. G09B 7/00; G06Q 10/10; G06Q 50/20; G09B 5/00

(52) U.S. Cl. CPC G09B 7/00; G09B 5/00; G06Q 10/105; G06Q 50/2057

(57) ABSTRACT

Personalized and targeted training systems and methods for controlling completion of an individualized training are described. An example method can commence with receiving a user performance report associated with a user and user data associated with the user. The user performance report includes user performance metrics. Based on the user performance report and the user data, a probability of completion of the individualized training by the user is predicted using multiple varying characteristics. If the probability is below a predefined completion threshold, at least one intervention action is applied to the user. Additionally, the method includes creating an individualized training based on the user data and at least one specific metric identified based on the user performance metrics. The individualized training includes training assignments designed to improve the at least one specific metric.

### CROSS-REFERENCE TO RELATED APPLICATIONS

The present utility patent application is related to and claims priority benefit of the U.S. provisional application No. 62/080,347, filed on Nov. 16, 2014 under 35 U.S.C. 119(e). The contents of the provisional application are incorporated herein by reference for all purposes to the extent that such subject matter is not inconsistent herewith or limiting hereof.

### TECHNICAL FIELD

The present disclosure relates generally to data processing and, more particularly, to methods and systems for personalized and targeted training based on performance and for predicting completion of the training.

### BACKGROUND

Current work environments can be increasingly demanding on professionals. There are multiple changes occurring in all professional spheres, including policy changes, emergence of new technologies, transition to new management systems, and so forth. Although training is critical to the performance of a professional, the amount of time a busy professional can spend on training is limited. Additionally, training needs even across the same division or specialty may be different, and the mix of performance across the individuals within a large organization can be highly variable. Furthermore, professional learners may need a flexible and self-paced training method accessible from various locations that will help initially learn, and subsequently drive proficiency with application of knowledge. Training that is also personalized, is known to boost attention during learning, with subsequent gains in long-term knowledge retention.

Furthermore, some professionals may be less likely to complete a training than the others, less likely to complete training earlier within a training period than the others, or less likely to be satisfied by a particular learning strategy than the others. Predicting the likelihood of completion, completion timing, and satisfaction with learning is important to avoid wasting valuable resources.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are personalized and targeted training systems and methods for predicting of completion, completion timing, and satisfaction of an individualized training. An example method may commence with receiving user performance data and user data. The user performance data may be received from an enterprise application, for example, an Electronic Health Record (EHR) system. The enterprise may include a clinic, a hospital, and so forth. The data may include performance data, professional data, previous training data, and so forth. The performance report may include user performance metrics. Based on the user performance data and the user data, the probability of completion of the individualized training by the user may be predicted, as well as timing to complete, and satisfaction of the individualized training. The probability may be predicted using multiple varying characteristics. When it is determined that the probability is below a predefined completion, completion timing, or satisfaction threshold, one or more intervention actions may be applied to increase the probability of completion, completion timing, or satisfaction of the individualized training.

In other embodiments, a method for personalized and targeted training may commence with receiving a user performance report. Additionally, the method may comprise receiving user data associated with the user. The data may include performance data, professional data, previous training data, and so forth. Performance of the user may be assessed against the performance metrics and scores of peers, which may be established for each of the metrics. Based on the scores, the training system may detect potential training areas for individual users. A threshold may be set for each metric. If the score of the user for a specific metric is below the threshold, a training need may be identified and the user may be assigned a training task corresponding to the specific metric. Based on the performance of the user, assignments designed to improve the specific metric can be created and an individualized training can be created based on the user data. Additionally, the individualized training may be further based, at least in part, on a division (i.e. specialty) of the user, role, department, site associated with the user, and so forth. Furthermore, the individualized training may be associated with practice settings (e.g., clinic, hospital) of the user. Upon request of the user, the individualized training may be provided to the user via a client device (e.g., a smart phone, a tablet PC, a laptop). The training may be provided in sessions, for example, 3-5 minutes long or longer.

To motivate the user, progress or performance of the user may be compared to the progress of other users and displayed within the assigned training. Thus, the training may be personalized to increase attention of the user during learning, which can result in greater retention of knowledge over time. For this purpose, multiple user performance metrics associated with further users and further user data may be received. The multiple user performance metrics associated with further users and further user data may be compared to further user data. Based on the comparison, at least one further user with similarities to the user may be selected. Training performance of the user may be benchmarked against the training performance of the at least one further user and displayed within the assigned training, thereby personalizing the training to increase the attention of the user and resulting in greater retention of knowledge over time.

In some embodiments, predictive technology and machine learning can be applied to determine training needs, set a threshold for performance metrics, and so forth. The machine learning techniques can be used to analyze data of user peers with similar roles and specialties or data of other users who have similar trainings needs.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements and, in which:

FIG. 1 illustrates an environment within which personalized and targeted systems and methods can be implemented, in accordance with some embodiments.

FIG. 2 is a block diagram showing various modules of a personalized and targeted training system, in accordance with certain embodiments.

FIG. 3 is a flow chart illustrating a method for predicting completion of an individualized training, in accordance with some example embodiments.

FIG. 4 is a graph illustrating a predicted completion model, in accordance with some example embodiments.

FIG. 5 is a graph illustrating matching of actual completion of a training to a predicted completion model, in accordance with some example embodiment.

FIG. 6 is a graph illustrating improving of actual completion of a training using a method for controlling completion of an individualized training, in accordance with some example embodiment.

FIG. 7 is a flow chart illustrating a method for personalized and targeted training, in accordance with some example embodiments.

FIG. 8 is an example performance report produced by an EHR system, in accordance with some example embodiments.

FIG. 9 shows an initial processing screen of the personalized and targeted training system, in accordance with some example embodiments.

FIG. 10 shows an assignment screen of the personalized and targeted training system, in accordance with some example embodiments.

FIG. 11 shows a user assignment summary screen of the personalized and targeted training system, in accordance with some example embodiments.

FIG. 12 shows a user screen of the personalized and targeted training system, in accordance with some example embodiments.

FIG. 13 shows a user performance screen, in accordance with some example embodiments.

FIG. 14 shows a training screen assigned to a user, in accordance with some example embodiments.

FIG. 15 is a block diagram illustrating a method for the personalized and targeted training, in accordance with some example embodiments.

FIG. 16 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

This disclosure provides personalized and targeted training methods and systems to assist professionals in meeting learning requirements in changing environments. A disclosed training system can target specific performance of a user and can be personalized to display the training progress of the user benchmarked against the progress of peers of the user. Performance of the user may be assessed using a user performance report and other data associated with the user, such as a user role, division, specialty, and so forth. The user performance report may include performance metrics against which the assessment may be performed. The purpose of the assessment may be to detect potential training areas for the user. When potential training areas are detected, an individualized training may be created. The individualized training may include one or more training assignments associated with the performance metric. This way, a training curriculum may be individualized for the user, making the training highly relevant and targeted. Upon creation of one or more individualized training sessions, the training may commence. Upon request of the user, the training sessions may be provided to the user via a client device.

Furthermore, the probability of completion of the training by the user may be predicted based on the user performance report and other data. If the probability is below a completion threshold, the personalized and targeted training system may define one or more intervention actions (e.g., notifications, e-learning, one-on-one trainer sessions, and so forth) and apply or suggest them to the user. Additionally, the personalized and targeted training system can generate a completion model reflecting predicted completion and completion timing of the training by a group of users. When the training is provided to the users and the users start completing the training, actual completion progress may be periodically monitored against the predicted completion model. If the personalized and targeted training system detects deviations of the actual completion and completion timing from the predicted completion model, further intervention actions may be defined and applied. Target users may include those who are most likely to not complete the training based on the predicted completion, and those who at that point in the training timeline should have completed training based on predicted completion timing. Thus, the personalized and targeted training system may affect the actual completion during the training process to achieve a higher completion rate than the completion rate without any intervention.

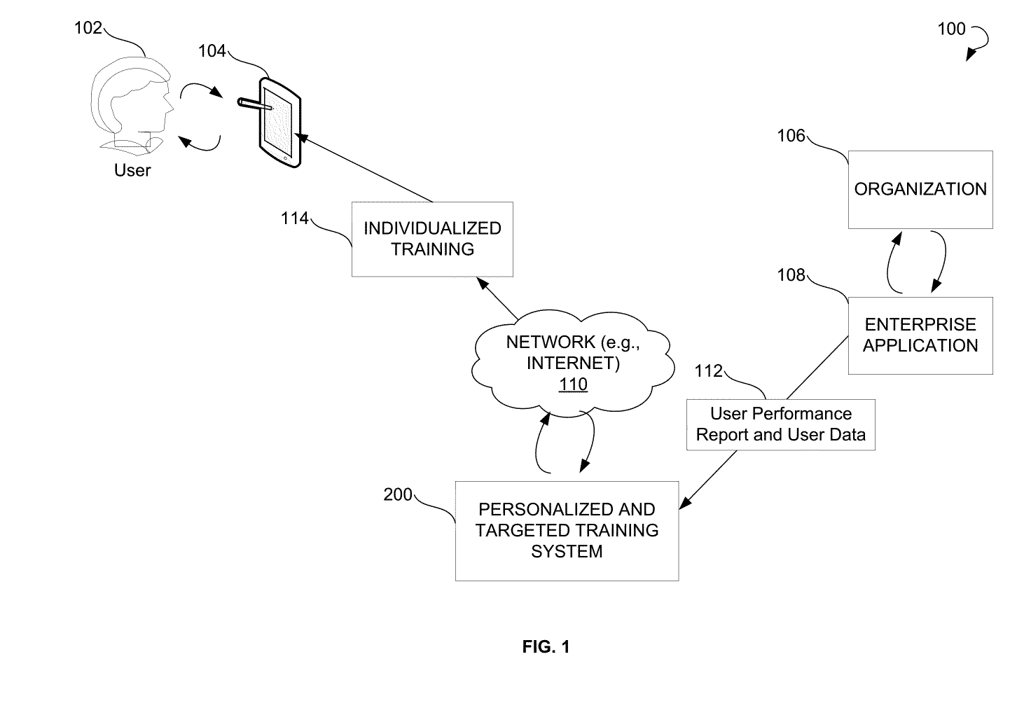

FIG. 1 illustrates an environment 100 within which personalized and targeted systems and methods can be implemented, in accordance to some embodiments. A personalized and targeted training system 200 can include a server-based distributed application. Therefore, it may include a central component residing on a server and one or more client applications residing on client devices and communicating with the central component via a network 110. At least one user 102 may communicate with the personalized and targeted training system 200 via a client application or web portal available through a client device 104, for example, a smart phone, a tablet PC, a laptop, and so forth.

The user 102 may be associated with an organization 106, for example, the user 102 can be an employee of the organization 106. The organization 106 may use the personalized and targeted training system 200 to provide certain skill trainings and to improve certain performance areas. The personalized and targeted training system 200 may be used by organizations across all industries, including Healthcare, Financial, Technology, Utilities, Consumer Goods, Services, and other industries.

In an example embodiment, the user 102 may include a healthcare professional (e.g., a physician, a surgeon, a nurse). The organization 106 utilizing user skills may include a healthcare organization such as, for example, a clinic, a hospital, a laboratory, and so forth. The healthcare organization may use or participate in a quality-based compensation model in order to better align the quality of care delivered and patient outcomes with reimbursement. Central to the quality-based compensation model is the use of and standardization of performance metrics, which may utilize a numerator/denominator format with exclusion criteria that can be benchmarked nationally to compare quality of care delivered. The National Quality Forum (NQF) is an example of standardized measures that are evidence-based and consistent with this goal and national initiatives to foster quality improvement in public and private sector healthcare organizations. Physicians are the key drivers of medical decisions in healthcare that impact patient outcomes, along with mid-level providers and other clinical staff that ultimately impact organizational-based, and individual provider-based performance/quality metrics. Sufficient performance on these metrics is associated with knowledge and understanding of the measured details (numerator, denominator, and exclusion criteria), supporting evidence, and management of patient disease. Furthermore, since reporting on most of the metrics is mediated in recent times through the use of electronic medical/health records type enterprise applications, correct and accurate use of electronic medical/health record systems as it pertains to the quality metrics is beneficial for accurate collection of data, reporting of performance, and overall performance. These performance metrics are related to initiatives such as meaningful use, Physician Quality Reporting System, Value-Based Purchasing, Value-Based Payment Modifier, Medicare Advantage, Accountable Care Organizations, Patient Centered Medical Homes, and other types of healthcare initiatives aimed at improving patient outcomes. Additionally, the performance metrics may be related to clinical documentation improvement strategies that help increase the accuracy of these measures to assess quality of care delivered, by ensuring appropriate risk stratifications of patients based on severity of illness and risk of mortality for a particular encounter.

Performance metrics are not necessarily limited to healthcare and are a key part in improving operations across other industries, and, especially, as related to the use of other types of enterprise applications, such as customer relationship management, supply chain management, enterprise resource planning, and other enterprise applications.

The personalized and targeted training system 200 may receive a user performance report and user data 112 from an enterprise application 108 related to the organization 106. In the healthcare industry, the user performance report may be associated with a national provider identifier (NPI) which identifies a physician and other health care providers in EHR system as well as publically reported user data. The user data may include a gender of the user, a specialty of the user, a time period after graduation, a type of practice associated with the user (a clinic, a hospital, and so forth), and other data. For example, the personalized and targeted training system 200 may use a combination of data from the enterprise and publically available data from CMS (Center for Medicaid and Medicare services) physician compare and hospital compare databases.

The user performance report may include performance metrics (e.g., outcome and resource use measures, patient satisfaction measures, composite performance measures, electronic quality measures, and so forth). Based on the performance metrics in the user performance report, a user score for each of the performance metrics may be determined and compared to the predetermined threshold. The performance metrics where the user score is below the predetermined threshold may be identified as potential training areas for the user 102. Furthermore, to provide an efficient training, the potential training areas may be analyzed using the user data (such as training assignments, role and specialty of the user), historical data related to trainings of similar users, and so forth. Based on the analysis, an individualized training 114 may be created for the user 102.

To control training completion, the personalized and targeted training system 200 can predict a probability of completion, completion timing, and satisfaction of individualized training by the user based on the user performance data and the user data. Prediction can be made by analyzing multiple varying characteristics. If the probability is below a predefined level, the personalized and targeted training system 200 can intervene with the training completion, completion timing, or satisfaction, for example, by sending reminders or notification to the user or his supervisor, by assigning additional live trainings to the user, and so forth.

The individualized training 114 can be provided to the user 102 in training sessions upon user request. The training sessions may be transmitted to the client device 104 via a network 110. The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The network 110 may include any suitable number and type of devices (e.g., routers and switches) for forwarding commands, content, and/or web object requests from each client to the online community application and responses back to the clients.

To motivate the user, the progress of the user 102 may be monitored and compared to the progress of other users. A comparison can be made to similar users. The similarities can be defined based on many criteria, such as, for example, same or similar specialty, a role, and so forth. Based on the comparison, the user progress may be benchmarked against the similar users. In some embodiments, a rank of the user can be calculated and provided to the users or displayed to the user.

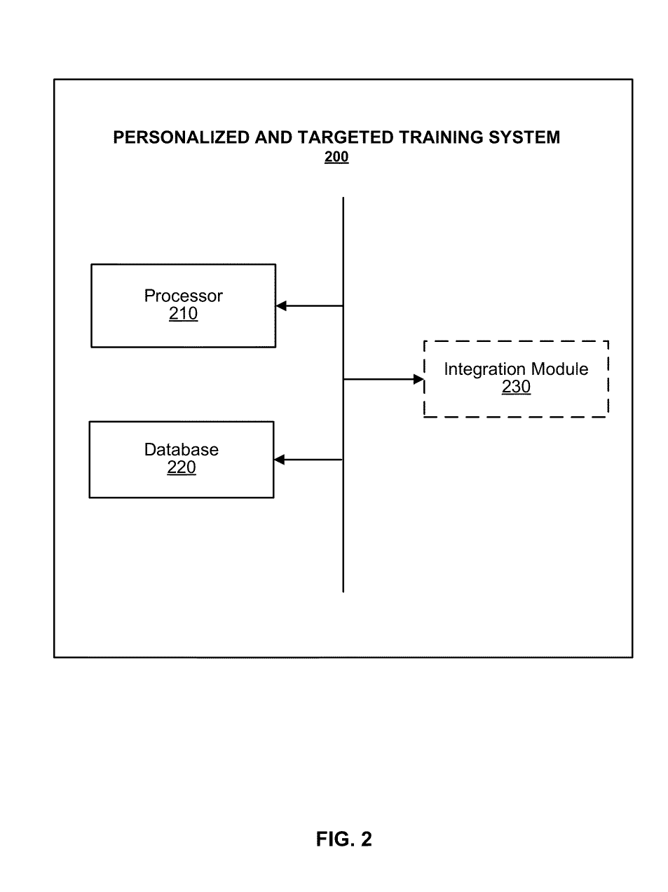

FIG. 2 is a block diagram showing various modules of the personalized and targeted training system 200, in accordance with certain embodiments. The personalized and targeted training system 200 may comprise a processor 210, a database 220, and an integration module 230. The processor 210 may include a programmable processor, such as a microcontroller, central processing unit, and so forth. In other embodiments, the processor 210 may include an application-specific integrated circuit or programmable logic array, such as a field programmable gate array, designed to implement the functions performed by the personalized and targeted training system 200.

In various embodiments, the personalized and targeted training system 200 may be deployed within the network of the organization or reside outside the organization in a data center outside control of the company and be provided as a cloud service. When the personalized and targeted training system 200 resides outside the organization in a data center, the user may access the personalized and targeted training system 200 via a client application on a client device or via a web browser.

The processor 210 can be operable to receive a user performance report, for example, from an enterprise application. The user performance report may include user performance metrics (e.g., outcome and resource use measures, composite performance measures, patient satisfaction, electronic quality measures, and so forth). Additionally, the processor 210 may be operable to receive user data associated with the user, such as user position, specialty, past user trainings, and so forth. The processor 210 may identify at least one specific metric of the performance metrics that is below a predetermined threshold and create an individualized training based on the user data and the at least one specific metric. In some embodiments, the individualized training may be created based on a unified training associated with the at least one specific metric. The individualized training may include training assignments designed to improve the at least one specific metric.

Furthermore, the processor 210 may predict, based on the user performance report and the user data, a probability of completion of the individualized training by the user using multiple varying characteristics. Additionally, the processor 210 may predict completion timing and completion satisfaction of the individualized training for the user. If the processor 210 determines that the probability is below a predefined completion (or completion timing or satisfaction) threshold, i.e. it is unlikely that the user will complete the training, the processor may create a list of intervention actions. The intervention actions may include sending notifications to the user or his supervisor, assigning certain resources to assist user in completing the individualized training, alternative training strategies, and other actions. The intervention actions may be applied to the user either automatically by the processor 210 or a responsible person may be informed about the intervention actions assigned to the user.

The database 220 may be operable to store at least the user performance report, the user data, the training assignments, the scores calculated for the user, the completion probability, completion timing probability, satisfaction of training probability, the completion model for a group of users, and so forth. The optional integration module 230 may be operable to selectively integrate and provide training sessions with an enterprise application to educate the user in context of a working environment.

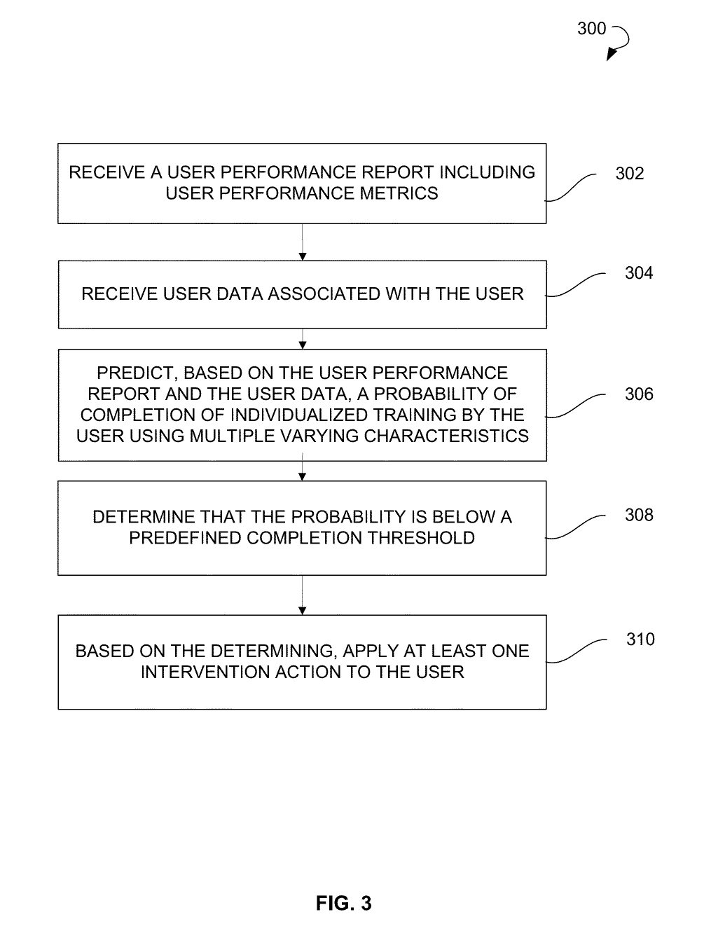

FIG. 3 is a flow chart illustrating a method 300 for controlling completion of a training, in accordance with some example embodiments. The method 300 may commence at operation 302 with receiving the user performance report including user performance metrics. The user performance report may include user data associated with NPI in EHR system, for example, historical user performance associated with at least one past training, patient care, or other productivity factors. Additionally, publicly available user data may be received at operation 304. The user data may include a gender of the user, a specialty of the user, years on the job, a type of practice associated with the user, relevant hospital performance, and so forth.

Based on the user performance report and the user data, at operation 306, the personalized and targeted training system 200 may predict a probability of completion of the training by the user using multiple varying characteristics for which a multi-varied analysis is run. For this purpose, a completion score may be calculated for the user. The completion score may be a number calculated based on multiple varying characteristics and representing factors that can influence the completion of the training by the user. Additionally, the personalized and targeted training system 200 may predict completion timing or satisfaction of the training for the user in a similar manner by calculating a completion timing score or a satisfaction score.

In one example, the completion score may be compared to a completion threshold to predict the likelihood of the user completing the training. If the completion score exceeds the completion threshold, it may be predicted that the user will complete the training and no additional actions are required. If the completion score is below the completion threshold, the personalized and targeted training system 200 may predict that the user will not complete the training at operation 308 and establish and apply intervention actions at operation 310 before or during the training to increase user probability of completion the training. The intervention actions may include messaging, assigning additional training assignments, assigning a one-on-one trainer to the user, and so forth. In some embodiments, it may be also determined whether the probability of the completion timing is below a predefined completion timing threshold, or the probability of satisfaction is below a predefined satisfaction threshold, and intervention actions may be identified and applied to the user. Additionally, the personalized and targeted training system 200 may calculate a timing score for the user to predict a time period of completing the training (for example, if the user is an early completer or late completer or somewhere in between). The completion score and the timing score may be used to generate a predicted completion model which predicts completion progress for a group of users.

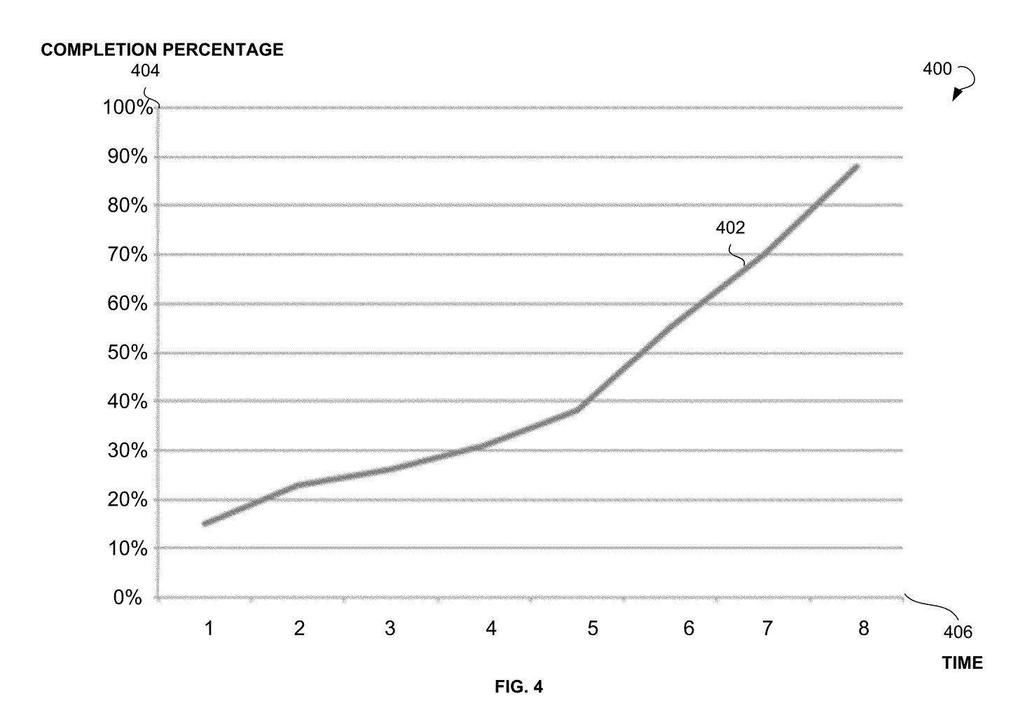

FIG. 4 shows a graph 400 illustrating the predicted completion model 402, in accordance with some example embodiments. The predicted completion model 402 can be generated for various groups of users. For example, the predicted completion model 402 can be generated for all learners in a domain or for a filtered group including one or more sites, one or more roles, one or more divisions, one or more specialties, and so forth. Additionally, the predicted completion model 402 may be created for a specific learning domain, e.g., a cognitive domain, a procedural domain, or a combined domain.

The predicted completion model 402 may show the predicted completion percentage 404 for the selected group of users against time 406 as defined for the training. The personalized and targeted training system 200 may use the predicted completion model 402 to monitor and control the progress of the completion of the individualized training. Furthermore, the personalized and targeted training system 200 may generate and provide further models showing predicted completion, completion timing, or satisfaction for an individual user or a group of users.

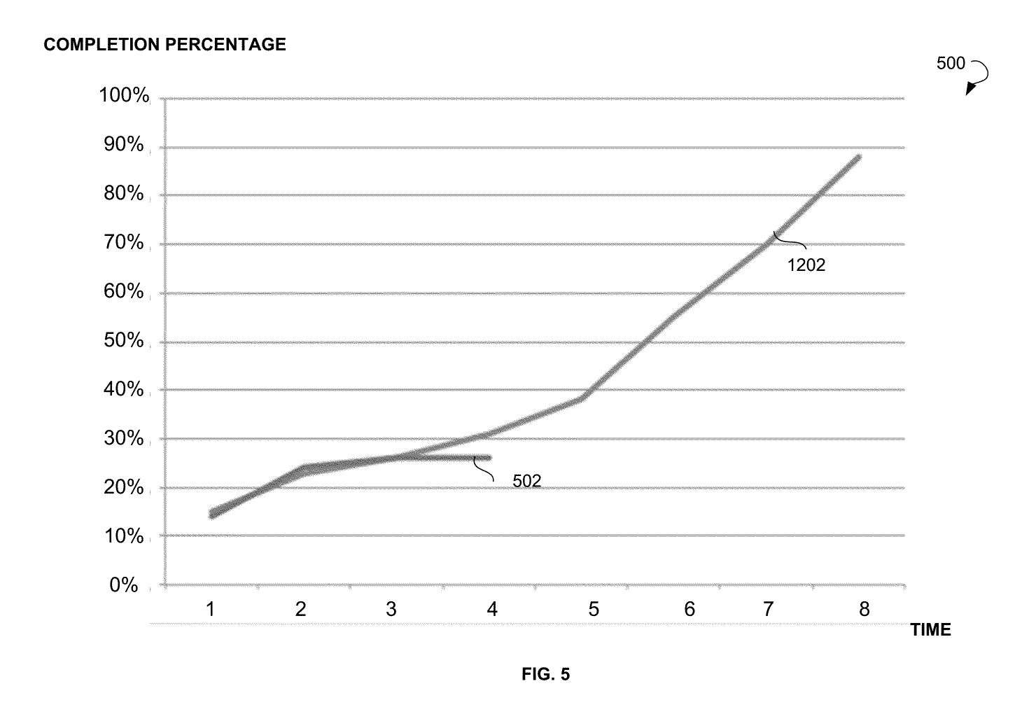

As illustrated by FIG. 5, data related to actual completion may be collected by the personalized and targeted training system 200 to monitor actual completion 502 of the training at graph 500. The actual completion 502 may be periodically matched to the predicted completion model 402. When a deviation of the actual completion 502 from the predicted completion model 402 is determined (as shown in FIG. 5), the personalized and targeted training system 200 may take an action with respect to the users who are expected to deviate. The intervention actions may include sending notifications to the users or their supervisors, providing additional training resources, and receiving feedback related to the training completion from the users.

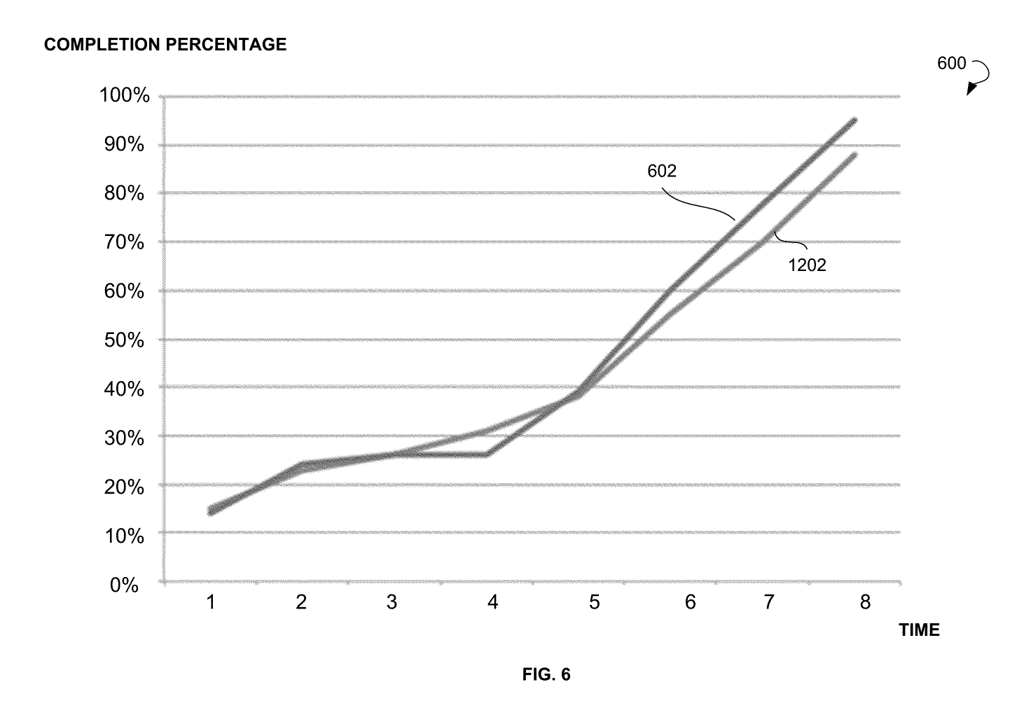

Due to the intervention actions, the personalized and targeted training system 200 may control actual completion and influence the completion results in the process of the training as shown by FIG. 6. Thus, actual completion 602 may be improved in relation to the predicted completion model 402. Such improvement is illustrated by graph 600.

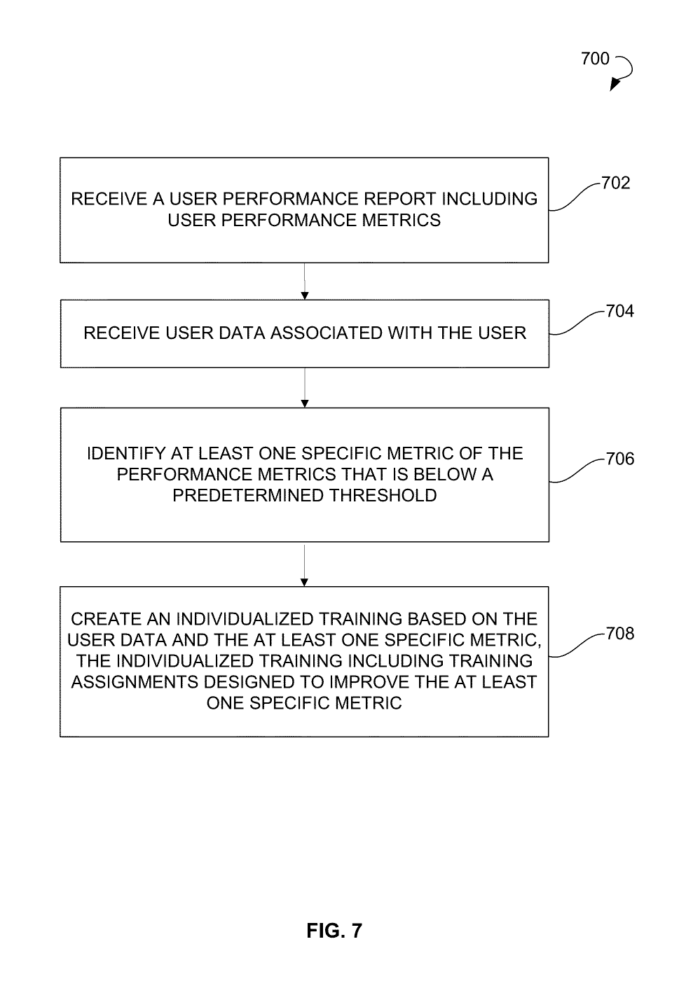

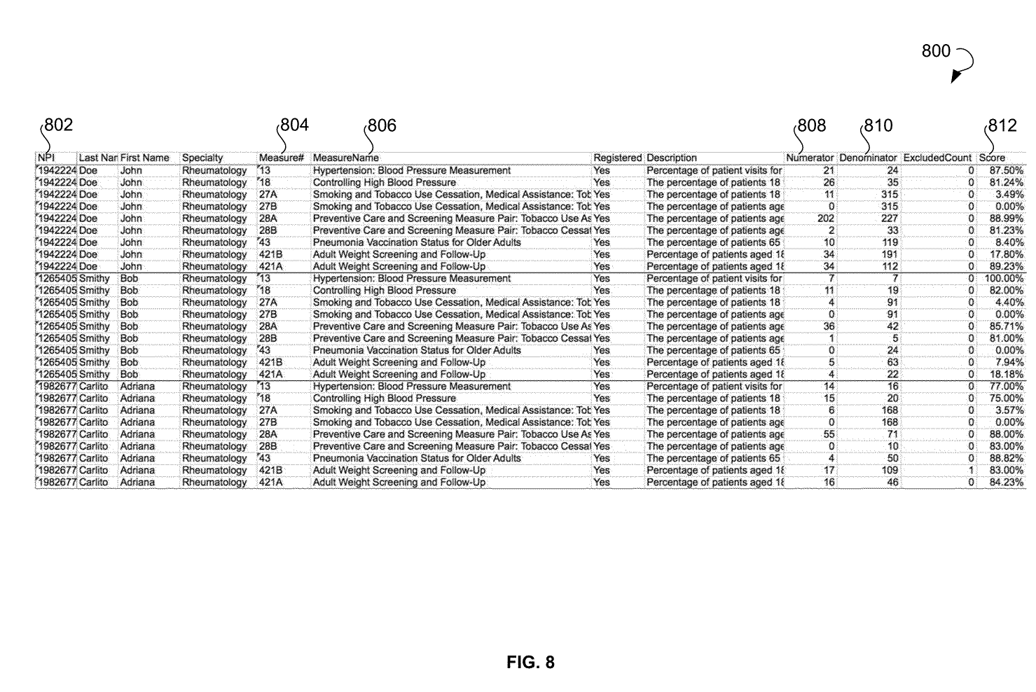

FIG. 7 is a flow chart illustrating a method 700 for personalized and targeted training, in accordance with some example embodiments. The method 700 may commence at operation 702 with receiving a user performance report detailing performance of the user with respect to specific metrics (see FIG. 8). Additionally, performance, specialization, and other data associated with the user may be received at operation 704. The user performance report and the user data may be analyzed to identify common performance metrics for users with similar learning requirements. Although training may be critical to the implementation of accurate use of performance metrics (understanding of the metric and use of the EHR related to the metric), it is not necessary that all users learn about all metrics. Based on the specialty and practice settings of the user (e.g., a clinic, a hospital, and so forth), some metrics are relevant and measurable, while others are not. Furthermore, even within the same specialty and practice settings, some users can be quite satisfactory on some measures, while others are not, and the mix of performance across the individuals within a large organization can be highly variable. To efficiently identify the performance metrics applicable to the user, predictive technology and machine learning methods may be used.

User performance can be assessed with regards to the identified performance metrics and user scores can be determined for each of the metrics. In some embodiments, the method may, optionally, include relating the identified performance metrics to a specific form of training (media or interaction) within the management system of the user. A type of training can be suggested using prediction technology and machine learning.

Based on the scores, the training system may determine performance gaps as potential training areas for the user. For this purpose, a threshold may be set for each metric. If the user score is below the threshold for a specific metric, a training opportunity may be identified at operation 706 and the user may be assigned a training area related to the metric. In some embodiments, reverse metrics may be applied. In that case, training can be assigned if the performance metric score of the user is above the threshold. Those performance metrics may be designated as a reverse metric.

The user score and assignment data may be processed and summarized into an individualized training at operation 708. Examples of the individualized training may include training assignments designed to improve at least one specific metric, a number of skills suggested by the training system for assignments based on specific specialties of the users in the report, average number of skills to assign per specialty, and so forth.

In some embodiments, the training manager and/or user may be provided with the ability to customize the suggested assignments. Thus, the training may be modified by the user according to his/her preferences in response to a modification request from the user.

The suggested skills may be assigned collectively to all users in the report (one by one or all at once with a single click, which may save time over performing these assignments individually across different systems). This way, a training curriculum may be individualized and assigned for each user, thereby making the training personalized and targeted. Thereafter, the user may request the training session by session from his client device whenever the user desires. The personalized and targeted training system 200 may personalize the training (media or interaction) that is delivered inside or outside the enterprise application or another application used to deliver training (with or without tracking) and include their score and average score of their peers (defined for example as peers within their division such as, for example, cardiology or marketing, or their role as a physician, nurse, senior vice president, and so forth). The personalized and targeted training system 200 can display the learning performance score of the user, in comparison to their peers within the personalized and targeted training system 200 or any other system used to deliver training to the user (for example, a content management system).

FIG. 8 shows an example user performance report 800, produced by an EHR system, in accordance with some example embodiments. The report lists, by individual, a unique identifier for the user (in this case NPI 802 for the healthcare provider), and information about the metric, such as measure number 804 (could be an NQF number), measure name 806, including a numerator 808, a denominator 810, and a performance score 812.

The performance report 800 can be processed by the personalized and targeted training system 200 locally or provided to an application associated with the personalized and targeted training system 200 via a direct interface with the enterprise application, such as EHR. The performance report 800 may be processed to extract performance metrics of the user to analyze them in view of the user data.

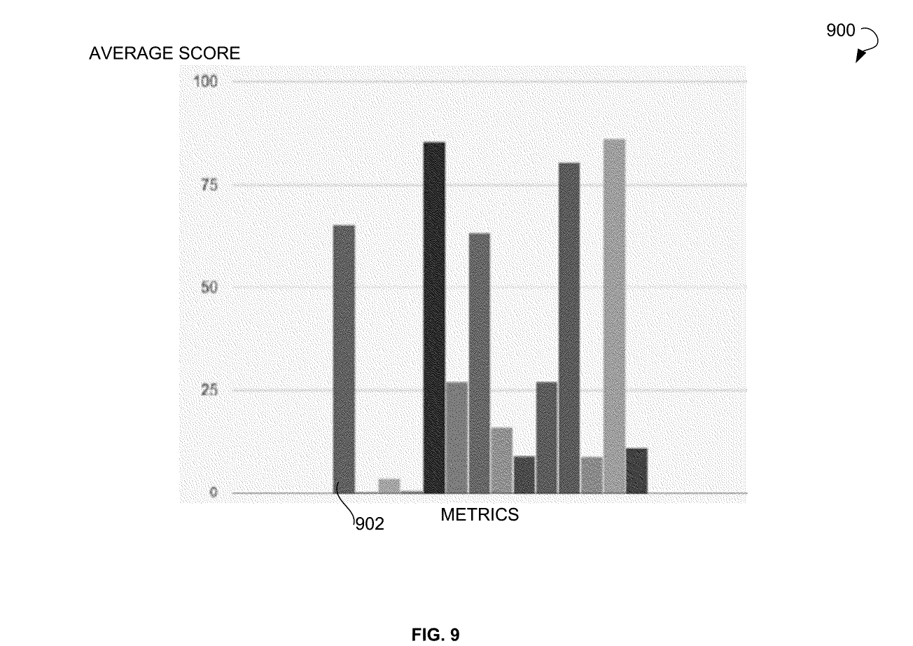

FIG. 9 shows an initial processing screen 900 of the personalized and targeted training system 200, in accordance with some example embodiments. The initial processing can identify the unique metrics across all users included in the performance report. An average score for all users in the performance report may be calculated for each metric. The metrics may be represented by columns 902 with the height of the column representing the average score of the metric for all users in the report.

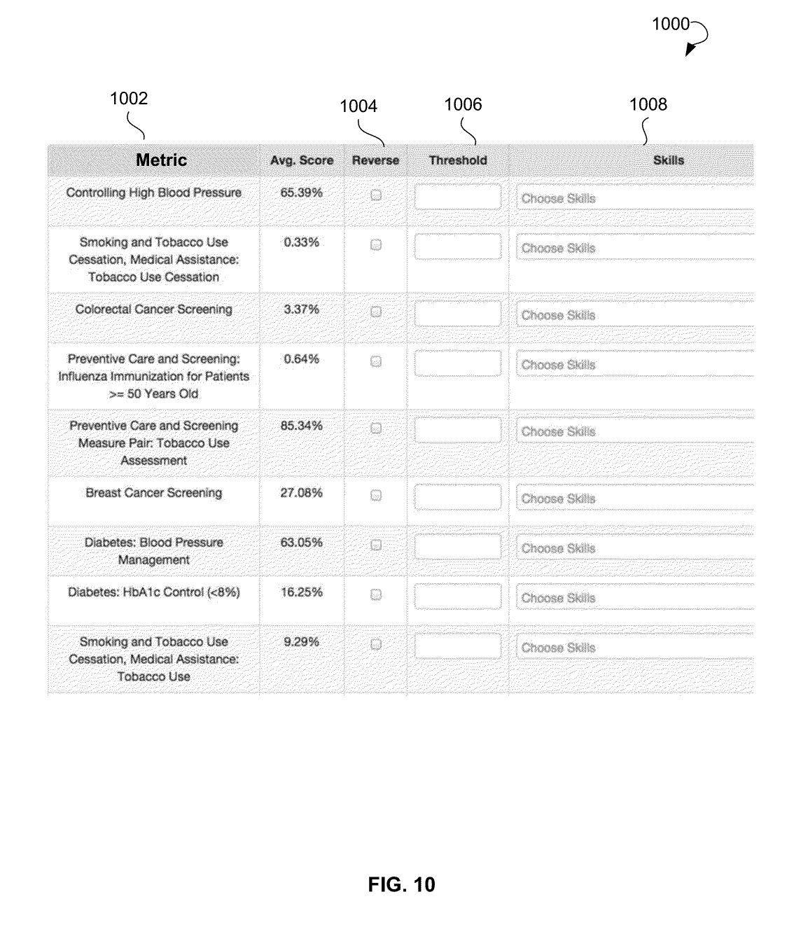

FIG. 10 shows an assignment screen 1000 of the personalized and targeted training system 200, in accordance with some example embodiments. The personalized and targeted training system 200 may create a table, which lists the metrics 1002 as shown. The user may identify the metric as a reverse metric 1004, set a threshold 1006 (if a performance score of the user is below the threshold 606, training is assigned unless this is a reverse metric 1004 in which case the reverse is true), and associate the metrics 1002 with training (media/interaction) by choosing one or more skills 1008 within the personalized and targeted training system 200. This data may also be suggested to the personalized and targeted training system 200 using predictive technology, or other settings preselected locally by the client, or at the federal level by initiatives that set a required passing threshold (e.g., a meaningful use initiative).

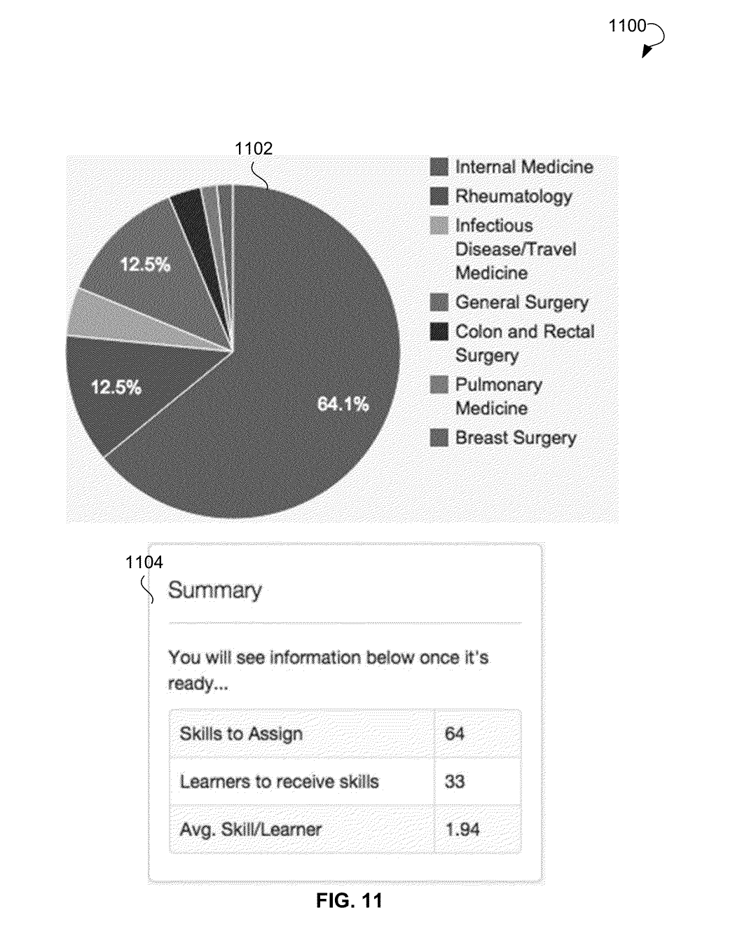

FIG. 11 shows a user assignment summary screen 1100 of the personalized and targeted training system 200, in accordance with some example embodiments. The personalized and targeted training system 200 can process the metrics information received from the performance report and specified at the assignment screen 1000 and display a user specialty graph 1102 visualizing the number of skills to be assigned, across specialties, and a summary 1104 of skills to assign, number of users to receive skills, and average number of skills to assign per user. The summary 1104 data is not restricted to these examples and can include other types of relevant data.

The training manager can evaluate, in more detail, the suggested assignments (by individual learner and metric) in a number of ways. The skills in the summary 1104 may be reviewed, modified, or submitted as is. The users meeting all of the aforementioned criteria may have skills assigned based on their individual performance.

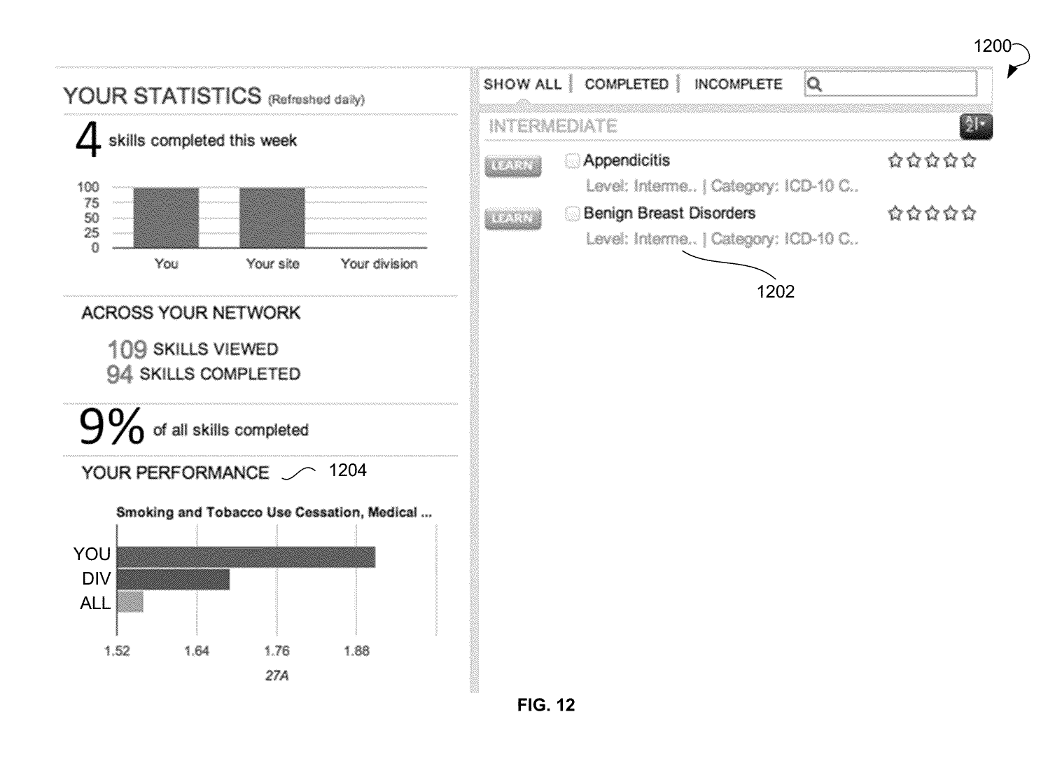

FIG. 12 shows a user screen 1200 of the personalized and targeted training system 200, in accordance with some example embodiments. The personalized and targeted training system 200 can be integrated with an external application, or include an internal component of the learner management system used to assign training. The user may access the user screen 1200 through the client device from any location. In this case, the training assignments 1202 associated with the user can be listed.

The user performance 1204 may be shown at the user screen 1200 either independently, or alongside benchmarks. Example benchmarks displayed in FIG. 12 can include learners in their division (in healthcare this would correlate to specialty), or all learners within a specified role (physician, nurse, Senior Vice President, and so forth).

The user can initiate a training session by selecting one of the training assignments 1202. When the training session is initiated, the learning media launches. The learning media can teach the user how to improve his performance (including information about the performance metric and anything else related to that performance). The training is personalized with performance of the user (either individually or in the context of benchmarks) to increase their motivation to learn, and to improve attention. The user is provided with his performance related to the initiated training assignment.

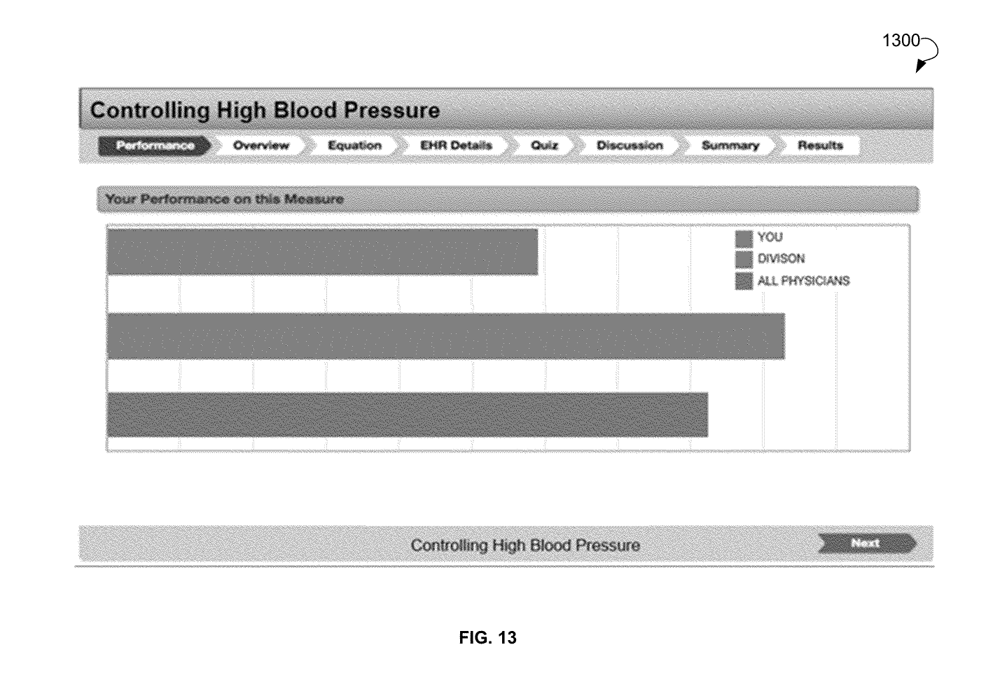

FIG. 13 shows a user performance screen 1300, in accordance with some example embodiments. The user assigned training screen 1300 can provide graphical information about the user performance associated with a specific performance metric in comparison to a mean performance value in the division, all users, and so forth.

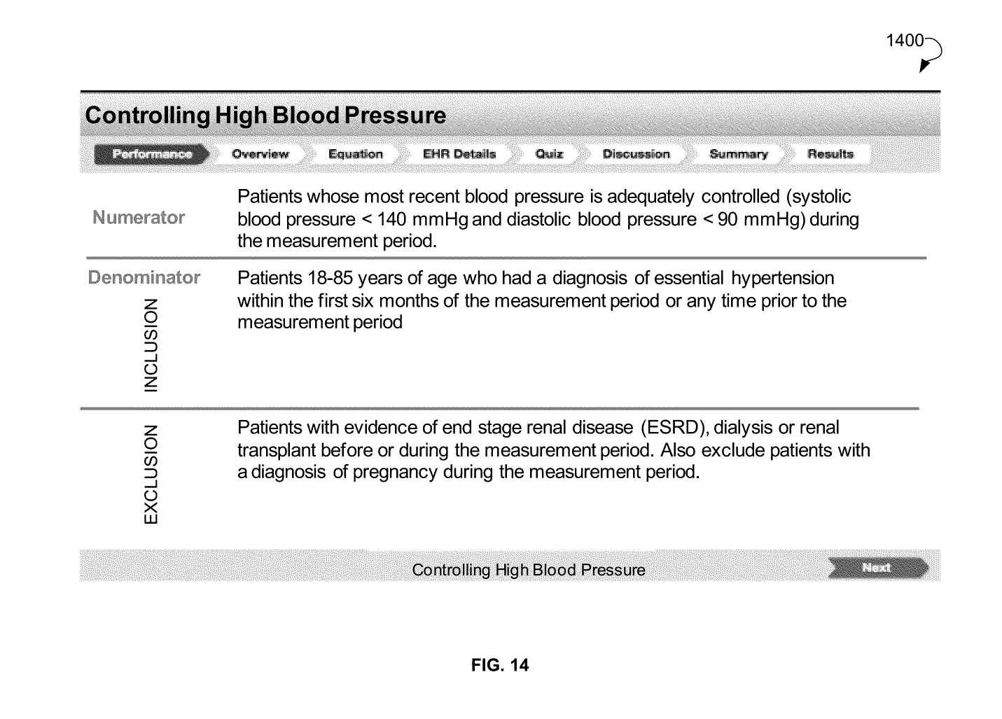

FIG. 14 shows a user assigned training screen 1400, in accordance with some example embodiments. The user assigned training screen 1400 can provide information about the performance metric and data related to improving user score or performance.

In some embodiments, data provided by external sources and from previous trainings can be retrieved and processed to generate new trainings and to verify correctness of the user answers during the training. Question answering systems, a prediction application programming interface, and other techniques may be used for this purpose. The data may be received from domain-specific content providers, as unstructured data from enterprise applications, from public and social domains, from proprietary content, and so forth. The data may be identified, contracted, acquired, cleansed and curated, aggregated and validated. The processed data may be then processed and published using question answering (e.g., Watson) and other systems.

Additionally, the question answering system may be enriched with relevant content. The question answering system may upload, ingest, and deploy the content. Additionally, with the help of the question answering system, public, subscribed and enterprise content may be acquired.

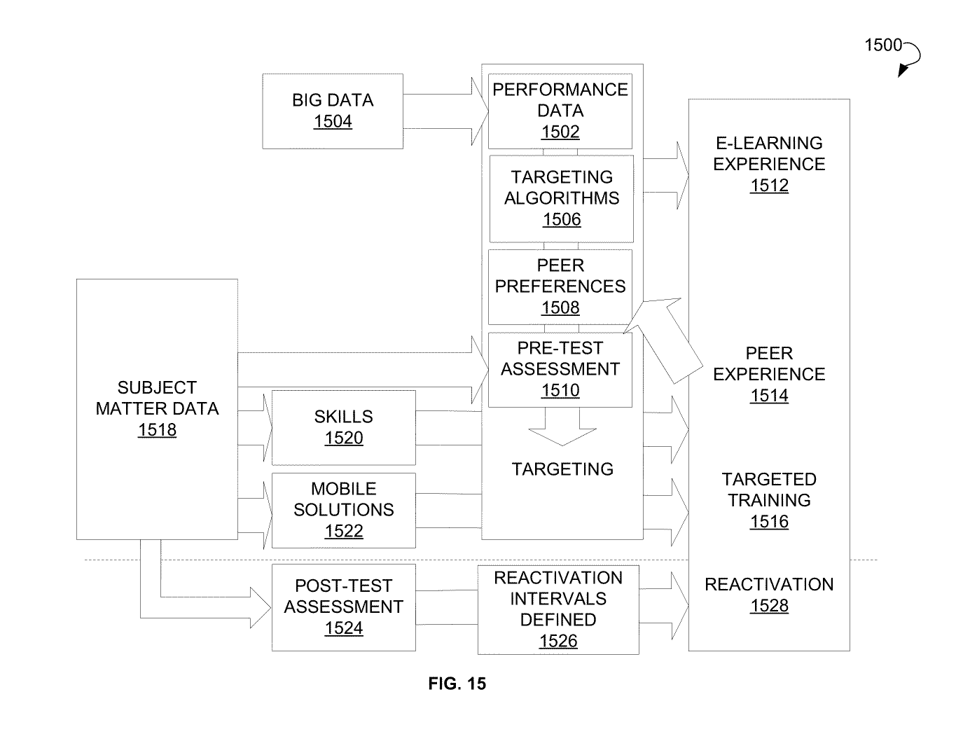

FIG. 15 shows a high-level diagram 1500 of the personalized and targeted training, in accordance with some example embodiments. The user performance data 1502 received based on big data 1504 from a client (organization) or publicly reported may be processed using targeted algorithms 1506. Subject matter data 1518 related to information to be learned, skills 1520, and mobile solutions 1522 are also processed to create a targeted and individualized training. Additionally, the processing may consider peer preferences 1508 and pre-test assessment 1510 to provide targeted training 1516 aimed at specific performance gaps of the user. The personalized and targeted training system 200 constantly collects e-learning experience 1512 and peer experience 1514 data and uses it to further improve training targeting and personalization.

In some embodiments, the subject matter data 1518 is also used for post-test assessment 1524. The post-test assessment 1524 may be conducted at reactivation intervals defined 1526 personally for the user in the personalized and targeted training system 200. Based on the post-test assessment 1524, the reactivation 1528 of the knowledge obtained due to the individualized training may be performed to decrease user retention decay.

Another aspect of the personalized and targeted training system 200 may be directed to predicting training completion by users and controlling the completion by intervening in advance.

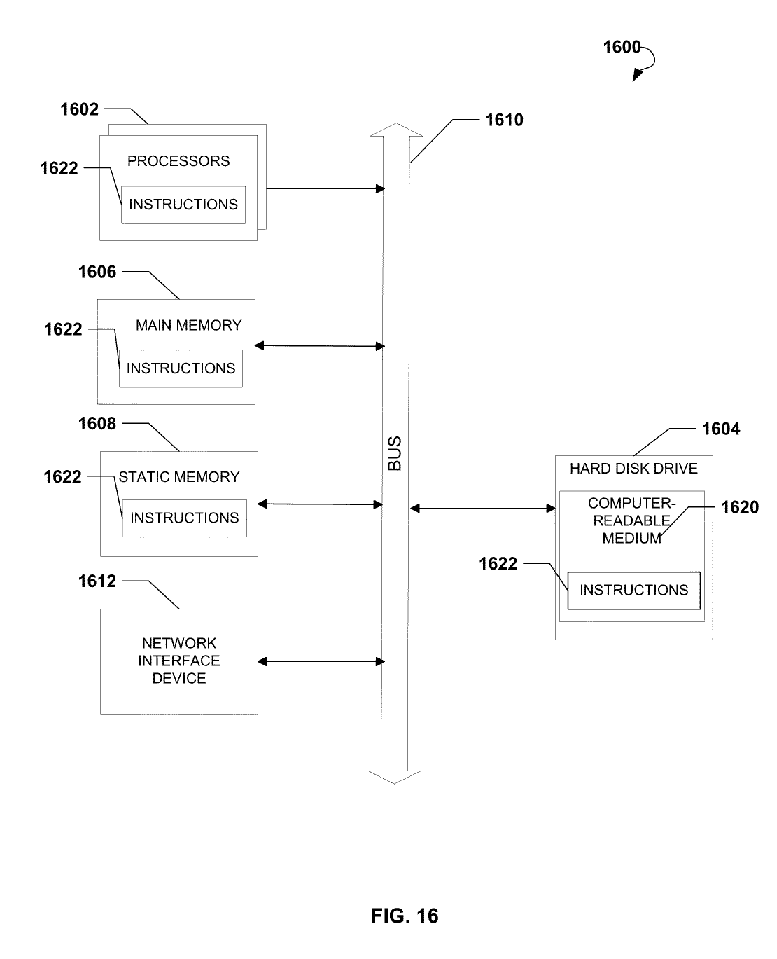

FIG. 16 shows a diagrammatic representation of a computing device for a machine in the exemplary electronic form of a computer system 1600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a cellular telephone, a portable music player (e.g., a portable hard drive audio device, such as an Moving Picture Experts Group Audio Layer 3 player), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor or multiple processors 1602, a hard disk drive 1604, a main memory 1606 and a static memory 1608, which communicate with each other via a bus 1610. The computer system 1600 may also include a network interface device 1612. The hard disk drive 1604 may include a computer-readable medium 1620, which stores one or more sets of instructions 1622 embodying or utilized by any one or more of the methodologies or functions described herein. The instructions 1622 can also reside, completely or at least partially, within the main memory 1606 and/or within the processors 1602 during execution thereof by the computer system 1600. The main memory 1606 and the processors 1602 also constitute computer-readable media 1620.

While the computer-readable medium 1620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random-Access Memory, Read Only Memory, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, personalized and targeted training systems and methods are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A method for controlling completion of an individualized training, the method comprising:
receiving, by a processor, a user performance report associated with a user, the user performance report including user performance metrics;
receiving, by the processor, user data associated with the user; and
predicting, based on the user performance report and the user data, a probability of completion of the individualized training by the user using multiple varying characteristics.

2. The method of claim 1, further comprising:
determining that the probability is below a predefined completion threshold; and
based on the determining, applying at least one intervention action to the user.

3. The method of claim 1, further comprising:
predicting, based on the user performance report and the user data, a probability of completion timing of the individualized training by the user and a probability of satisfaction associated with the completion of the individualized training by the user, wherein the predicting is performed using multiple varying characteristics;
determining one or more of the following: that the probability of the completion timing is below a predefined completion timing threshold, and the probability of satisfaction is below a predefined satisfaction threshold; and
based on the determining, applying at least one intervention action to the user.

4. The method of claim 1, wherein the user performance report includes historical user performance associated with at least one past individualized training.

5. The method of claim 1, wherein the user data includes one or more of the following: a gender of the user, a specialty of the user, a time period after graduation, and a type of practice associated with the user.

6. The method of claim 1, further comprising:
based on the predicting, creating a predicted completion model for the user;
continuously receiving data related to actual completion of the individualized training by the user;
repeatedly comparing the predicted completion model with the actual completion of the individualized training;
based on the comparing, detecting a deviation of the actual completion of the individualized training; and
based on the detection, applying at least one intervention action to the user.

7. The method of claim 1, wherein at least one intervention action includes one or more of the following: sending one or more notifications, further monitoring of the user, sending one or more notifications to a supervisor of the user, assigning an additional training session to the user, and assigning a one-on-one trainer to the user.

8. The method of claim 1, wherein the predicting includes performing a multi-varied analysis across the multiple varying characteristics.

9. The method of claim 1, further comprising:
determining a user score for each of the user performance metrics;
comparing the user score to a predetermined threshold to identify at least one specific metric of the user performance metrics that is below a predetermined threshold; and
creating the individualized training based on the user data and the at least one specific metric, the individualized training including training assignments designed to improve the at least one specific metric.

10. A method for personalized and targeted training, the method comprising:
receiving, by a processor, a user performance report, the user performance report including user performance metrics;
receiving, by the processor, user data associated with a user;
identifying, by the processor, at least one specific metric of the user performance metrics that is below a predetermined threshold; and
creating, by the processor, an individualized training based on the user data and the at least one specific metric, the individualized training including training assignments designed to improve the at least one specific metric.

11. The method of claim 10, wherein the individualized training is further based at least in part on a specialty of the user, a role of the user, practice settings of the user, and historical data related to trainings of further users.

12. The method of claim 10, wherein the user performance metrics include one or more of the following: outcome and resource use measures associated with the user, composite performance measures associated with the user, and electronic quality measures associated with the user.

13. The method of claim 10, further comprising:
receiving multiple user performance metrics associated with further users;
receiving further user data associated with the further users;
comparing the user data to the further user data; and
based on the comparison, selecting at least one further user with similarities to the user, wherein the similarities include one or more of the following: a specialty of the user, a role of the user, and practice settings of the user; and
benchmarking user performance associated with the training assignments against performance of the at least one further user associated with the training assignments.

14. The method of claim 13, further comprising:
calculating a rank of the user based on the user performance and the performance of the at least one further user; and
displaying the rank of the user to the user.

15. The method of claim 10, wherein the identifying includes determining a user score for each of user performance metrics and comparing the user score to the predetermined threshold.

16. The method of claim 10, further comprising:
receiving, by the processor from the user, a request for providing at least one of the training assignments, wherein the request is sent from a device associated with the user; and
based on the request, providing to the device associated with the user the at least one of the training assignments.

17. The method of claim 10, further comprising:
receiving, from the user, one or more modification requests associated with the individualized training; and
based on the one or more modification requests, modifying the individualized training.

18. The method of claim 10, wherein the training assignments are selected based on one or more of the following: a number of skills suggested to assign based on unique specialties among users and average number of skills to assign per a specialty.

19. A personalized and targeted training system comprising:
a processor configured to:
receive a user performance report, the user performance report including user performance metrics;
receive user data associated with a user;
identify at least one specific metric of the performance metrics that is below a predetermined threshold;
create an individualized training based on the user data and the at least one specific metric, the individualized training including training assignments designed to improve the at least one specific metric, wherein the individualized training is provided to the user;
predict, based on the user performance report and the user data, a probability of completion of the individualized training by the user using multiple varying characteristics;
determine that the probability is below a predefined completion threshold; and
based on the determining, apply at least one intervention action to the user; and
a database in communication with the processor, the database being configured to store at least the user performance metrics and the user data.

20. The system of claim 19 further comprising an integration module configured to selectively integrate the individualized training with an enterprise application to educate the user in context of a working environment.
